(19) United States
(12) Patent Application Publication
(10) Pub. No.: US 2026/0131244 A1
(43) Pub. Date: May 14, 2026

(54) METHOD AND COMPUTERIZED SYSTEM FOR PROCESSING GAME INFORMATION, AND COMPUTER-READABLE STORAGE MEDIUM

(71) Applicant: Yidian Lingxi Information Technology (Guangzhou) Co., Ltd., Guangdong (CN)

(72) Inventor: Tiandao Huang, Guangdong (CN)

(73) Assignee: Yidian Lingxi Information Technology (Guangzhou) Co., Ltd., Guangdong (CN)

(21) Appl. No.: 19/029,585

(22) Filed: Jan. 17, 2025

(30) Foreign Application Priority Data
Nov. 11, 2024 (CN) 202411606600.2

(51) Int. Cl. A63F 13/57; A63F 13/52

(52) U.S. Cl. CPC A63F 13/57; A63F 13/52

(57) ABSTRACT

The disclosure provides a information processing method and computerized system for game, and an electronic device and a storage medium. The method includes: displaying on a game interface of a user a plurality of virtual characters that participate in a virtual combat and are shown entering a first phase of the virtual combat; receiving a first input from the first virtual character for selecting a candidate character from a candidate group, and displaying the target virtual character determined based on the first input from the plurality of virtual characters for selecting candidate characters from the candidate group; and displaying the plurality of virtual characters entering a second phase of the virtual combat, and matching an attack route in the virtual combat for the target virtual character determined in the first phase.

### CROSS-REFERENCE TO RELATED APPLICATION

This application claims priority to Chinese Patent Application No. 202411606600.2, filed on Nov. 11, 2024, which is hereby incorporated by reference in its entirety.

### TECHNICAL FIELD

The present disclosure relates to the technical field of game data processing, and particularly, to an information processing method for implementation by a device that executes a game, a computerized system for providing information processing in a game, and a non-transitory computer-readable storage medium.

### BACKGROUND

With the rapid development of the gaming industry, multiplayer games have gradually become mainstream, allowing multiple users to collaborate, undertake quests, or engage in combat and other activities within the game. In existing multiplayer games, multiple users can form a team and participate in combats as a team. During the combat, the team leader typically directs the members of the team to attack along a specified attack route. However, when users form teams on their own, the efficiency of team formation is relatively low, and the attack routes are limited to the decisions of the team leader, significantly extending the pre-combat preparation time and impacting the user experience.

### SUMMARY

One purpose of the embodiments of the present disclosure is to provide a new technical solution for processing game information.

According to a first aspect of the present disclosure, there is provided an information processing method for implementation by a device that executes a game, the method comprising: displaying, by a processor, on a game interface of a user a plurality of virtual characters that participate in a virtual combat and are shown entering a first phase of the virtual combat, wherein the first phase is configured to determine a target virtual character that acts with a preset identity in the virtual combat, and the plurality of virtual characters includes a first virtual character of the user;
during the first phase, receiving, by the processor, a first input from the first virtual character for selecting a candidate character from a candidate group, and displaying, by the processor, the target virtual character determined based on the first input from the plurality of virtual characters for selecting candidate characters from the candidate group; wherein the candidate group comprises at least a portion of the plurality of virtual characters; and
displaying, by the processor, on the game interface the plurality of virtual characters entering a second phase of the virtual combat, and matching, by the processor, an attack route in the virtual combat for the target virtual character determined in the first phase.

In one possible implementation, the method further comprises:
during the first phase, displaying, by the processor, on the game interface selection options corresponding to each candidate character within the candidate group; wherein the candidate group is determined based on character attributes of the plurality of virtual characters, and the candidate group comprises a portion of the plurality of virtual characters, and the selection options include character information and selection controls of corresponding candidate characters;
said “receiving a first input from the first virtual character for selecting a candidate character from a candidate group” comprises:
receiving, by the processor, the first input from the first virtual character to execute selection of a candidate character by triggering the selection control.

In one possible implementation, wherein there are provided at least two of the target virtual characters; the method further comprising:
during the second phase, displaying, by the processor, on the game interface candidate results of the plurality of virtual characters selecting candidate characters from the candidate group, and determining, by the processor, an attack route for each target virtual character based on priorities thereof reflected by the candidate results; wherein the attack routes corresponding to different target virtual characters differ at least in a preset first route attribute.

In one possible implementation, wherein at least two of the target virtual characters include a second virtual character and a third virtual character, the method further comprising:
during the second phase, receiving, by the processor, a second input from the first virtual character for previewing a first attack route matched for the second virtual character by triggering a first preview control, and displaying, by the processor, first route information of the first attack route based on the second input; wherein the first route information includes first attack strongholds configured for the first attack route in the virtual combat; or
receiving, by the processor, a third input from the first virtual character for previewing a second attack route matched for the third virtual character by triggering a second preview control, and displaying, by the processor, second route information of the second attack route based on the third input; wherein the second route information includes second attack strongholds configured for the second attack route in the virtual combat, and at least a portion of the first attack strongholds and the second attack strongholds have different geographical locations in the virtual combat.

In one possible implementation, wherein the first route attribute includes:
number of attack strongholds indicated for attack along the attack route;
quantity of resources obtained after occupying the attack strongholds indicated for attack along the attack route; and
attribute strength preset for the attack strongholds indicated for attack along the attack route.

In one possible implementation, wherein the plurality of virtual characters include a fourth virtual character, the fourth virtual character being in the same camp as the first virtual character in the virtual combat; the method further comprising:
during the second phase, in response to an attack indication from the first virtual character to initiate an attack on the fourth virtual character, displaying, by the processor, that the first virtual character is prohibited from initiating an attack on the fourth virtual character.

In one possible implementation, wherein the plurality of virtual characters include a fifth virtual character, the fifth virtual character being in the same camp as the first virtual character in the virtual combat; when the first virtual character has the preset identity, the method further comprising:
displaying, by the processor, configuration of an attack team by the first virtual character, wherein the virtual characters in the attack team attack along the attack route;
in response to an application by the fifth virtual character to join the attack team, displaying, by the processor, an application approval option for the fifth virtual character; and
when the first virtual character indicates agreement with the application approval option, displaying, by the processor, the fifth virtual character joining the attack team.

In one possible implementation, wherein the method further comprises:
during a third phase, displaying, by the processor, the attack team initiating an attack along the attack route; and
displaying, by the processor, the attack team receiving resource replenishments from a support team, wherein the support team includes virtual characters from the plurality of virtual characters other than those in the attack team.

According to a second aspect of the present disclosure, there is also provided a computerized system for providing information processing in a game, the system comprising: an interface display; a memory, configured for storing a computer program; and a processor, configured for executing operations under control of the computer program, the operations comprising:
displaying, by a processor, on a game interface of a user a plurality of virtual characters that participate in a virtual combat and are shown entering a first phase of the virtual combat, wherein the first phase is configured to determine a target virtual character that acts with a preset identity in the virtual combat, and the plurality of virtual characters includes a first virtual character of the user;
during the first phase, receiving, by the processor, a first input from the first virtual character for selecting a candidate character from a candidate group, and displaying the target virtual character determined based on the first input from the plurality of virtual characters for selecting candidate characters from the candidate group; wherein the candidate group comprises at least a portion of the plurality of virtual characters; and
displaying, by the processor, on the game interface the plurality of virtual characters entering a second phase of the virtual combat, and matching, by the processor, an attack route in the virtual combat for the target virtual character determined in the first phase.

According to a third aspect of the present disclosure, there is also provided a non-transitory computer-readable storage medium is provided, which stores instructions, when executed by a processor, cause the processor to perform a method for information processing in a game, the method comprising: displaying, by the processor, on a game interface of a user a plurality of virtual characters that participate in a virtual combat and are shown entering a first phase of the virtual combat, wherein the first phase is configured to determine a target virtual character that acts with a preset identity in the virtual combat, and the plurality of virtual characters comprises a first virtual character of the user; during the first phase, receiving, by the processor, a first input from the first virtual character for selecting a candidate character from a candidate group, and displaying, by the processor, the target virtual character determined based on the first input from the plurality of virtual characters for selecting candidate characters from the candidate group; wherein the candidate group comprises at least a portion of the plurality of virtual characters; and displaying, by the processor, on the game interface the plurality of virtual characters entering a second phase of the virtual combat, and matching, by the processor, an attack route in the virtual combat for the target virtual character determined in the first phase.

According to a fourth aspect of the present disclosure, there is also provided a computer program product containing a game program. When the game program is executed, it causes the computer to perform the steps of the method for processing game information described above.

According to a fifth aspect of the present disclosure, there is also provided an electronic device comprising a memory and a processor. The memory stores a computer program, and the processor is configured to execute the method for processing game information described above via the computer program.

One beneficial effect of the embodiments of the present disclosure is that the method for processing game information provided can select target virtual characters from a candidate group during the first phase of a virtual combat. The target virtual characters are matched with attack routes in the virtual combat, allowing other virtual characters to team up with the target virtual characters and follow the matched attack routes for attacks. This effectively improves the efficiency of team formation and allows for targeted matching of attack routes for selected target virtual characters, thereby shortening pre-combat preparation time and enhancing the user experience.

Through the following detailed description of exemplary embodiments of this specification with reference to the accompanying drawings, the features and advantages of the embodiments of this specification will become clear.

### BRIEF DESCRIPTION OF THE DRAWINGS

The drawings, which are incorporated in and constitute a part of this specification, illustrate embodiments of the present disclosure and, together with the description, serve to explain the principles of the embodiments.

FIG. 1 illustrates a hardware structure diagram of an electronic device that can be used to implement the method for processing game information according to embodiments of the present disclosure;

FIG. 2 illustrates a flowchart of the method for processing game information according to some embodiments;

FIG. 3 illustrates a schematic diagram of a game interface according to other embodiments;

FIG. 4 illustrates a schematic diagram of a game interface according to other embodiments;

FIG. 5 illustrates a schematic diagram of a game interface according to other embodiments;

FIG. 6 illustrates a schematic diagram of a game map according to other embodiments;

FIG. 7 illustrates a structural diagram of the game information processing apparatus according to some embodiments;

FIG. 8 illustrates a hardware structure diagram of an electronic device according to some embodiments.

FIG. 9 illustrates a schematic diagram of an operating environment of a computerized system for providing information processing in a game according to some embodiments.

### DETAILED DESCRIPTION

The following is a detailed description of various exemplary embodiments of this specification with reference to the accompanying drawings.

The description of at least one exemplary embodiment herein is merely illustrative and does not impose any limitation on the embodiments of this specification or their applications or uses.

It should be noted that similar numerals and letters in the following drawings denote similar items, and accordingly, once an item is defined in one drawing, it does not need to be further discussed in subsequent drawings.

It should be clarified that all actions of acquiring signals, information, or data in the embodiments of this disclosure are carried out in compliance with the local country's relevant data protection laws and regulations and with authorization from the respective device owners.

Furthermore, it should be noted that the terms “first,” “second,” etc., used in the description of this application and the claims and drawings are for distinguishing similar objects and do not necessarily describe a specific order or sequence.

It should be understood that data used in this manner can be interchangeable in appropriate situations, allowing the embodiments described herein to be implemented in sequences other than those illustrated or described. Additionally, the terms “include” and “have” and any variations thereof are intended to cover non-exclusive inclusion, meaning that processes, methods, systems, products, or devices need not be limited to those steps or components clearly listed but may include others not explicitly listed or inherent to such processes, methods, products, or devices.

The embodiments of the present disclosure provide a new method for processing game information, which allows users to control a first virtual character to participate in a virtual combat. This first virtual character has the right to select the team leader of an attack team and the right to apply to join an attack team. Once the first virtual character joins an attack team, it can initiate attacks along the attack route of that team. This approach shortens pre-combat preparation time and enhances the user experience.

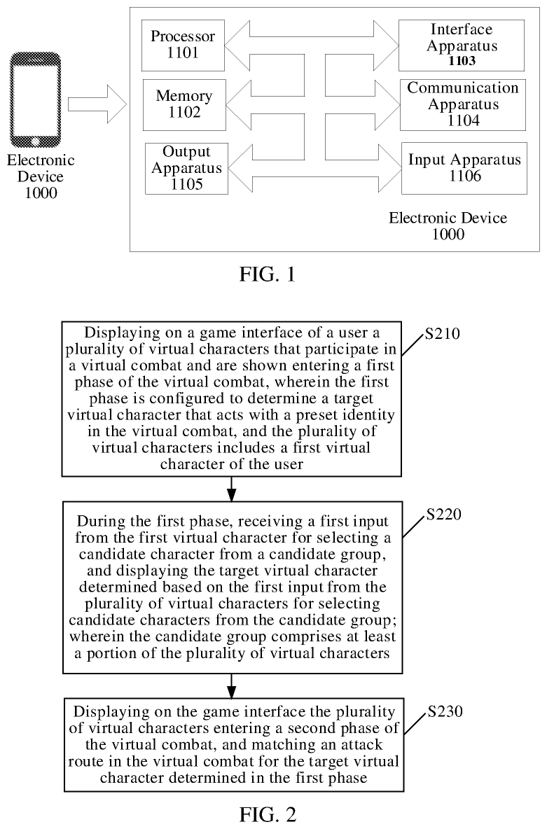

FIG. 1 illustrates a hardware structure diagram of an electronic device that can be used to implement the method for processing game information according to embodiments of the present disclosure.

The electronic device 1000 is capable of running games, which can be local applications installed on the electronic device, web-based games, light applications, or mini-programs, among others, with no specific limitations. The electronic device 1000 can be a smartphone, tablet computer, PC, etc., with no specific limitations.

As shown in FIG. 1, the electronic device 1000 may include a processor 1101, memory 1102, interface apparatus 1103, communication apparatus 1104, output apparatus 1105, input apparatus 1106, and so forth. The hardware configuration depicted in FIG. 1 is illustrative only and is not intended to limit the present disclosure, its applications, or uses.

The processor 1101 is used to execute computer programs, which can be written using instruction sets from architectures such as x86, Arm, RISC, MIPS, SSE, etc. The memory 1102 may include ROM (Read-Only Memory), RAM (Random Access Memory), non-volatile storage such as hard drives, etc. The interface apparatus 1103 may include USB interfaces, Ethernet ports, headphone jacks, etc. The communication apparatus 1104 is capable of wired or wireless communication and may include at least one short-range communication module, such as modules based on HiLink protocol, WiFi (IEEE 802.11 protocol), Mesh, Bluetooth, ZigBee, Thread, Z-Wave, NFC, UWB, LiFi, and other short-range wireless communication protocols. It can also include long-range communication modules for WLAN, GPRS, 2G/3G/4G/5G communications. The output apparatus 1105 may include LCD screens or touchscreens, speakers, etc. The input apparatus 1106 may include touchscreens, keyboards, microphones, various sensors, etc. In this embodiment, the memory 1102 of the electronic device 1000 is used to store a computer program that controls the processor 1101 to operate and execute the method for processing game information described in any embodiment of the present disclosure.

Next, taking the electronic device 1000 illustrated in FIG. 1 as the implementation subject, various embodiments of the method for processing game information will be explained.

### First Embodiment

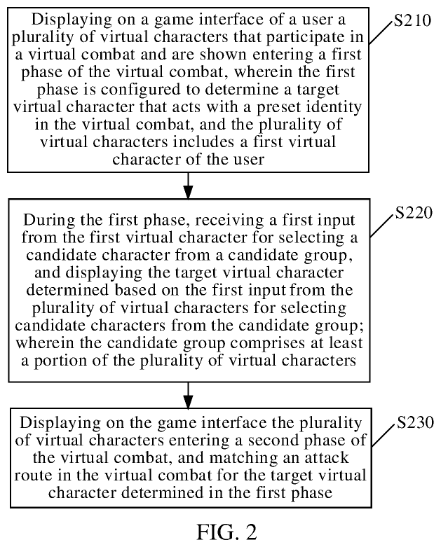

FIG. 2 illustrates a method for processing game information according to some embodiments, which can include the following steps S210 to S230:
Step S210, displaying on a game interface of a user a plurality of virtual characters that participate in a virtual combat and are shown entering a first phase of the virtual combat, wherein the first phase is configured to determine a target virtual character that acts with a preset identity in the virtual combat, and the plurality of virtual characters comprises a first virtual character of the user.

In this embodiment, a user refers to a player in the game who can control the first virtual character to join a virtual combat. Such virtual combat generally involves multiple virtual characters engaging in activities within one or more game scenes. Activities can include cooperation among virtual characters, undertaking quests, or engaging in combat, etc.

In this embodiment, entry into the first phase of the virtual combat is triggered when the game meets certain preset conditions, such as the number of participating virtual characters reaching a first preset number, the game progress reaching a preset time, or the initiator of the virtual combat determining to start it.

In this embodiment, the virtual combat has multiple phases. The first phase involves selecting the target virtual character from among the plurality of virtual characters. The second phase involves joining the attack team that includes the target virtual character. The third phase involves each attack team initiating attacks along their respective attack routes. The preset identity of the target virtual character can be that of an administrator, owner, or team leader of the attack team, meaning the target virtual character has the authority to administrate the attack team.

Step S220, during the first phase, receiving a first input from the first virtual character for selecting a candidate character from a candidate group, and displaying the target virtual character determined based on the first input from the plurality of virtual characters for selecting candidate characters from the candidate group; wherein the candidate group comprises at least a portion of the plurality of virtual characters.

In this embodiment, the candidate group can be determined from among the plurality of virtual characters, after they enter the virtual combat. The candidate group is selected from among the plurality of virtual characters, and consists of virtual characters that meet specific candidate criteria, such as having combat power reaching a preset value, having obtained honors reaching a second preset number, or having gameplay duration reaching a preset length.

In this embodiment, the first input can be made by the first virtual character selecting an option corresponding to the candidate character. Selection can be done by triggering a selection control corresponding to the candidate character or by entering specific information about the candidate character in a preset input box, such as the character name or a specific honorary title.

In this embodiment, the determined target virtual character is displayed during a specific time period within the first phase, such as 2 minutes, 5 minutes, or 10 minutes before the end of the first phase.

Step S230, displaying on the game interface the plurality of virtual characters entering a second phase of the virtual combat, and matching an attack route in the virtual combat for the target virtual character determined in the first phase.

In this embodiment, the virtual combat can have preset attack routes, which can be multiple, and the target virtual characters can also be multiple, each potentially associated with an attack route.

According to the first embodiment of the method for processing game information of the present disclosure, it addresses the issues in the prior art where users form teams on their own, leading to low efficiency in team formation, and where the attack routes are limited to decisions made by the team leader of the team, significantly extending pre-combat preparation time. Based on this method, during the first phase of the virtual combat, target virtual characters are selected from among the candidate group, and these target virtual characters are matched with attack routes in the virtual combat. This allows other virtual characters to team up with the target virtual characters and undertake attacks along the matched attack routes of the target virtual characters, effectively improving the efficiency of team formation. At the same time, it enables targeted matching of attack routes for the selected target virtual characters, thereby shortening pre-combat preparation time and enhancing the user experience.

### Second Embodiment

In this embodiment, to facilitate users in quickly selecting candidate characters and further enhance the user experience, during the first phase, the game interface displays selection options corresponding to each candidate character within the candidate group for users to choose a candidate character based on the character information provided by these options.

In these embodiments, relative to the aforementioned first embodiment, prior to step S220, the method further includes the following step S310:
Step S310, during the first phase, displaying on the game interface selection options corresponding to each candidate character within the candidate group; wherein the candidate group is determined based on character attributes of the plurality of virtual characters, and the candidate group comprises a portion of the plurality of virtual characters, and the selection options comprise character information and selection controls of corresponding candidate characters.

In this embodiment, the virtual characters in the candidate group can be those that have reached a preset attribute value in the first character attribute among the plurality of virtual characters, or they can be the top-ranking virtual characters in terms of attribute values in the second character attribute. For instance, the candidate group could consist of the top 3 or top 5 virtual characters based on their attribute values. Character attributes generally refer to the combat power, health points, or level of the virtual characters.

Based on this, step S220 can include the following sub-step S2201:
Step S2201, receiving the first input from the first virtual character to execute selection of a candidate character by triggering the selection control.

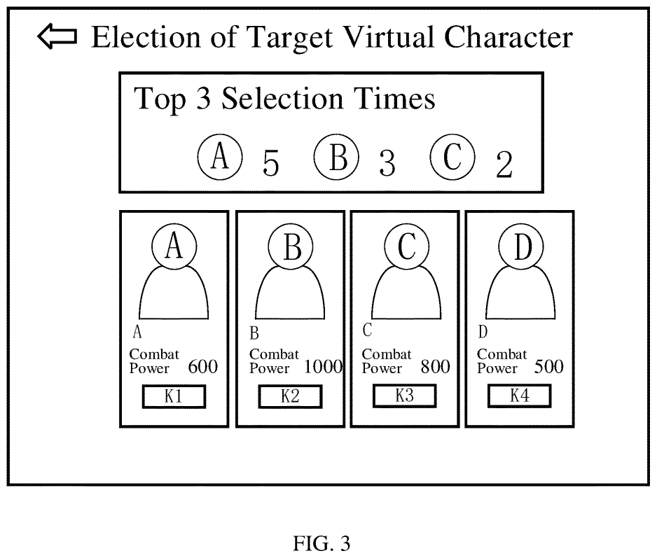

In this embodiment, taking the game interface shown in FIG. 3 as an example, users can view a page for electing target virtual characters during the first phase of the virtual combat. This page displays selection options for each candidate character within the candidate group, namely Virtual Characters A to D. For the selection option corresponding to Virtual Character A, it shows that Virtual Character A has a combat power of 600 and the character name “A,” along with a selection control K1 for choosing Virtual Character A as the target virtual character. For the selection option corresponding to Virtual Character B, it shows that Virtual Character B has a combat power of 1000 and the character name “B,” along with a selection control K2 for choosing Virtual Character B as the target virtual character. For the selection option corresponding to Virtual Character C, it shows that Virtual Character C has a combat power of 800 and the character name “C,” along with a selection control K3 for choosing Virtual Character C as the target virtual character. For the selection option corresponding to Virtual Character D, it shows that Virtual Character D has a combat power of 500 and the character name “D,” along with a selection control K4 for choosing Virtual Character D as the target virtual character. This game interface also displays the number of times each candidate character has been selected by multiple virtual characters, i.e., Virtual Character A has been selected 5 times, Virtual Character B 3 times, and Virtual Character C 2 times.

According to the method for processing game information of the second embodiment of the present disclosure, it addresses the issues in the prior art where users find it difficult to obtain character information about candidate characters within the candidate group and where selecting a candidate character is cumbersome. Based on the method in this embodiment, users can select a candidate character by reviewing the selection options for each candidate character during the first phase, enabling them to quickly select a candidate character and further enhancing the user experience.

### Third Embodiment

In this embodiment, to facilitate users in quickly selecting a target virtual character for application to join during the second phase of the virtual combat, there are at least two target virtual characters. The game interface can display candidate results for at least two target virtual characters and the attack routes corresponding to these target virtual characters.

In these embodiments, relative to the aforementioned first embodiment, following step S230, the method further includes the following step S410:
Step S410, during the second phase, displaying on the game interface candidate results of the plurality of virtual characters selecting candidate characters from the candidate group, and determining an attack route for each target virtual character based on priorities thereof reflected by the candidate results; wherein the attack routes corresponding to different target virtual characters differ at least in a preset first route attribute.

In some examples, multiple attack routes are preset with a matching sequence, and the attack route matched to each target virtual character is determined based on the priority of each target virtual character and the matching sequence. For example, if the plurality of attack routes are Attack Routes Z1 to Z3, and the matching sequence is Attack Route Z1, Attack Route Z2, and then Attack Route Z3. The priority of each target virtual character is based on their combat power, with attack routes assigned in descending order of combat power. If the target virtual characters ranked by combat power from highest to lowest are Virtual Character F to Virtual Character H, then Virtual Character F would be matched with Attack Route Z1, Virtual Character G with Attack Route Z2, and Virtual Character H with Attack Route Z3.

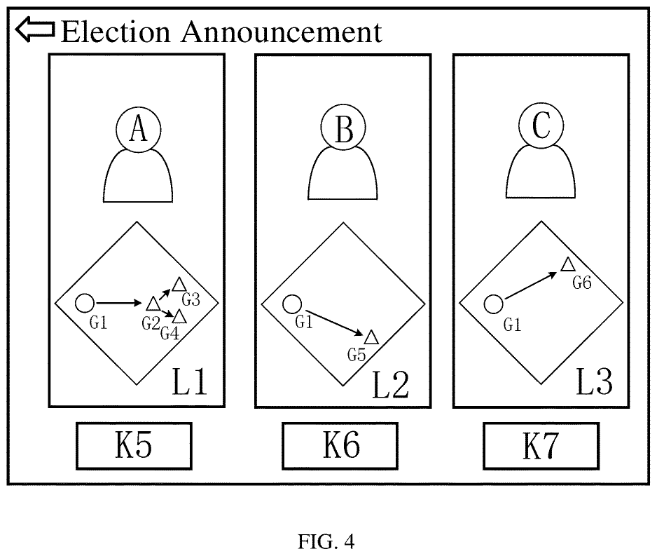

In this embodiment, taking the game interface shown in FIG. 4 as an example, during the second phase of the virtual combat, users can view a page displaying election results. This game interface shows a page for election announcements, which displays the candidate results, with Virtual Characters A to C being designated as target virtual characters. Virtual Character A is matched with Attack Route L1, Virtual Character B with Attack Route L2, and Virtual Character C with Attack Route L3.

In some embodiments, to enhance the rationality of the attack routes matched to each target virtual character, the first route attribute includes the number of attack strongholds indicated for attack along the attack route, the quantity of resources obtained after occupying the attack strongholds indicated for attack along the attack route, and the attribute strength preset for the attack strongholds indicated for attack along the attack route.

In this embodiment, taking the game interface shown in FIG. 4 as an example, the priority of Virtual Character A is higher than that of Virtual Character B. The attack route matched to Virtual Character A is Attack Route L1, while the attack route matched to Virtual Character B is Attack Route L2. Attack Route L1 indicates attacks on Attack strongholds G1 to G4, whereas Attack Route L2 indicates attacks on Attack stronghold G1 and Attack stronghold G5. Alternatively, for instance, if the priority of Virtual Character A is higher than that of Virtual Character B, the quantity of resources obtained after occupying Attack stronghold G2 is greater than that obtained after occupying Attack stronghold G5. Additionally, for instance, the priority of Virtual Character A being higher than that of Virtual Character B, the attribute strength preset for Attack stronghold G2 being greater than that preset for Attack stronghold G5, etc. Here, the attribute strength generally refers to the defensive power or health points of the attack stronghold, among others.

According to the method for processing game information of the third embodiment of the present disclosure, it addresses the issues in the prior art where users find it difficult to obtain candidate results and the attack routes for target virtual characters. Based on the method of this embodiment, users can quickly determine the team they need to join during the second phase by viewing the displayed election announcement page, facilitating rapid team formation and thereby achieving a reduction in the duration of pre-combat preparation.

### Fourth Embodiment

In this embodiment, to provide the first virtual character with attack routes matched to each selected target virtual character after selecting the target virtual characters, the at least two target virtual characters can include a second virtual character and a third virtual character. The first virtual character can view the first attack route for the second virtual character or the second attack route for the third virtual character, enabling the first virtual character to choose an appropriate team based on the attack routes matched to each target virtual character, thereby achieving the goal of rapid team formation for the first virtual character.

In these embodiments, relative to the aforementioned third embodiment, the method further includes the following steps S510 and S520:
Step S510, during the second phase, receiving a second input executed by the first virtual character through triggering a first preview control to preview a first attack route matched for the second virtual character, and displaying first route information of the first attack route based on the second input; wherein the first route information comprises first attack strongholds configured for the first attack route in the virtual combat.

In this embodiment, the second input can be an option for the first virtual character to select the first attack route matched to the second virtual character. This selection option for the first attack route matched to the second virtual character can be executed by triggering the first preview control corresponding to the second virtual character, or it can be done by entering specific information corresponding to the second virtual character into a preset input box. The specific information could be, for example, the character name of the second virtual character or a specific honorary title thereof, etc.

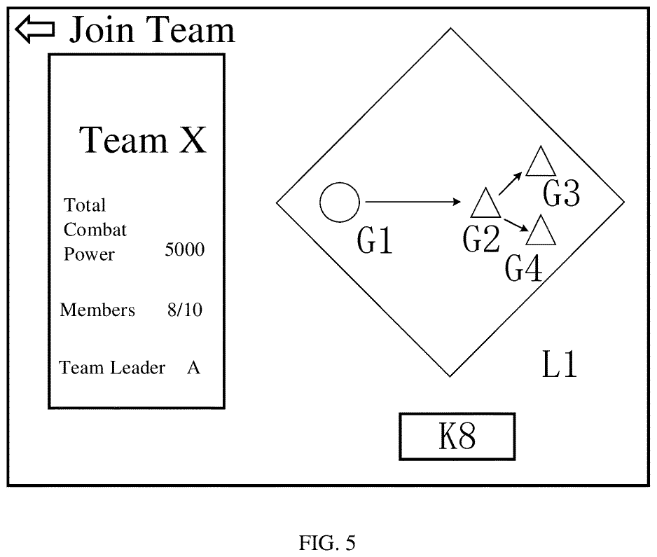

In this embodiment, taking the game interface shown in FIG. 4 as an example, when the user clicks the first preview control K5 of Virtual Character A (i.e., treating Virtual Character A as the second virtual character), the user's game interface switches from the interface in FIG. 4 to that in FIG. 5. The game interface in FIG. 5 displays that Virtual Character A is part of Team X, which has a total combat power of 5000, a maximum team size of 10 members, and currently has 8 members. The team leader of Team X is Virtual Character A. This game interface also shows Attack Route L1 as the first attack route. The first route information for Attack Route L1 indicates that it configures the first attack strongholds G1 to G4 in the virtual combat. The virtual characters of Team X can sequentially attack the first attack strongholds G1, G2, G3, or they can also sequentially attack the first attack strongholds G1, G2, G4.

Step S520, receiving a third input executed by the first virtual character through triggering a second preview control to preview a second attack route matched for the third virtual character, and displaying second route information of the second attack route based on the third input; wherein the second route information comprises second attack strongholds configured for the second attack route in the virtual combat, and at least a portion of the first attack strongholds and the second attack strongholds have different geographical locations in the virtual combat.

In this embodiment, the third input can be an option for the first virtual character to select the second attack route matched to the third virtual character. This selection option for the second attack route matched to the third virtual character can be executed by triggering the second preview control corresponding to the third virtual character or by entering specific information corresponding to the third virtual character into a preset input box. The specific information could be, for example, the character name of the third virtual character or a specific honorary title thereof, etc.

In this embodiment, taking the game interface shown in FIG. 4 as an example, when the user clicks the first preview control K5 of Virtual Character A (thus treating Virtual Character A as the second virtual character), the user's game interface switches from the interface in FIG. 4 to that in FIG. 5. The game interface in FIG. 5 displays that Virtual Character A is part of Team X, which has a total combat power of 5000, a maximum team size of 10 members, and currently has 8 members. The team leader of Team X is Virtual Character A. This game interface also shows Attack Route L1 as the first attack route. When the user needs to view the second attack route matched to Virtual Character B, the user clicks the “Join Team” control in FIG. 5, causing the game interface to switch back from the interface in FIG. 5 to that in FIG. 4. On the game interface of FIG. 4, the user can then click the second preview control K6 of Virtual Character B (thus treating Virtual Character B as the third virtual character). Subsequently, the user can view the second route information corresponding to the second attack route on the game interface.

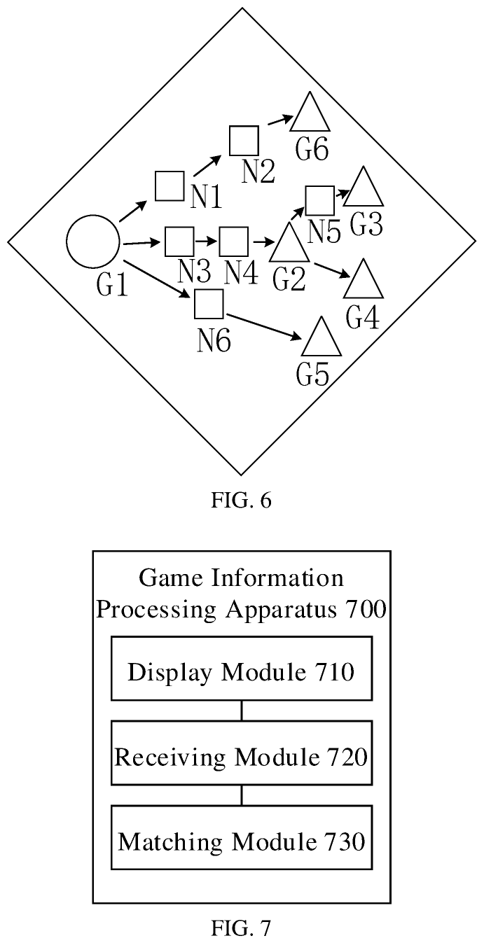

In this embodiment, taking the game map shown in FIG. 6 as an example, the first attack route can correspond to the first attack strongholds G1, G2, G3, and G4, while the second attack route can correspond to the first attack stronghold G1 and the first attack stronghold G5. Moreover, the first attack strongholds G2, G3, G4, and the second attack stronghold G5 each correspond to different geographical locations on the game map preset for the virtual combat. This means that the team of Virtual Character A and the team of Virtual Character B need to occupy different attack strongholds, which reduces the overlap of the gaming experience for each user participating in the virtual combat.

In this embodiment, to further enhance the interaction between users and the virtual combat, the teams of target virtual characters also need to capture fortress strongholds. The first route information also includes first fortress strongholds provided between the first attack strongholds, with these first fortress strongholds provided between at least two first attack strongholds. Similarly, the second route information also includes second fortress strongholds provided between the second attack strongholds, with these second fortress strongholds provided between at least two second attack strongholds. Taking the game map shown in FIG. 6 as an example, the game map is also configured with first fortress strongholds N3 to N5. The first fortress strongholds N3 and N4 are provided between the first attack strongholds G1 and G2, and first fortress stronghold N5 is provided between the first attack strongholds G2 and G3.

### Fifth Embodiment

In this embodiment, to reduce the memory consumption caused by the virtual combat, the plurality of virtual characters can include a fourth virtual character. The fourth virtual character and the first virtual character are in the same camp within the virtual combat and are prohibited from attacking each other during the virtual combat.

In these embodiments, relative to the aforementioned first embodiment, the method can include the following step S610:
Step S610, during the second phase, in response to an attack indication from the first virtual character to initiate an attack on the fourth virtual character, displaying that the first virtual character is prohibited from initiating an attack on the fourth virtual character.

In this embodiment, during the first phase of the virtual combat or before the virtual combat begins, the first virtual character can attack the fourth virtual character under instruction of the user. However, during the second phase of the virtual combat, when the user instructs the first virtual character to attack the fourth virtual character, the user's game interface displays a prompt message indicating that the first virtual character is prohibited from attacking the fourth virtual character.

### Sixth Embodiment

In this embodiment, to facilitate the administration of the attack team by the user acting as the team leader, the plurality of virtual characters can include a fifth virtual character. The fifth virtual character and the first virtual character are in the same camp within the virtual combat, and when the fifth virtual character applies to join the team of the first virtual character, the first virtual character can indicate whether the fifth virtual character is allowed to join the team.

In these embodiments, relative to the aforementioned fourth embodiment, when the first virtual character has a preset identity, the method can include the following steps S710 to S730:
Step S710, displaying configuration of an attack team by the first virtual character, wherein the virtual characters in the attack team attack along the attack route.

In this embodiment, other virtual characters can also participate in the virtual combat. These other virtual characters generally refer to virtual characters that are from opposing camps to the plurality of virtual characters.

In this embodiment, when the first virtual character is selected as the target virtual character, the user's game interface can display the attack team configured by the first virtual character.

Step S720, in response to an application by the fifth virtual character to join the attack team, displaying an application approval option for the fifth virtual character.

In this embodiment, taking the game interface shown in FIG. 5 as an example, the user controlling the fifth virtual character can click the confirmation control K8 to apply for joining Attack Team X, thereby instructing the fifth virtual character to apply for joining Attack Team X. The game interface of the user controlling Virtual Character A can display the application approval items for the fifth virtual character.

Step S730, when the first virtual character indicates agreement with the application approval option, displaying the fifth virtual character joining the attack team.

In this embodiment, taking the game interface shown in FIG. 5 as an example, when the fifth virtual character joins Team X, the number of members in Team X can increase from 8 to 9, and the total combat power of Team X can be adjusted according to the combat power of the fifth virtual character.

### Seventh Embodiment

In this embodiment, to enhance the sense of participation for all virtual characters involved in the virtual combat, virtual characters that have not joined any team are formed into a support team to provide resource replenishments for the attack team. Additionally, upon the end of the virtual combat, they receive corresponding combat rewards.

In these embodiments, relative to the aforementioned sixth embodiment, the method further includes the following steps S810 and S820:
Step S810, during a third phase, displaying the attack team initiating an attack along the attack route.

Step S820, displaying the attack team receiving resource replenishments from a support team, wherein the support team includes virtual characters from the plurality of virtual characters other than those in the attack team.

In some examples, the target virtual characters are Virtual Characters A to C, while the support team consists of Virtual Characters J to L. Virtual Characters J to L can undertake quests such as production or transportation to obtain game resources, and the resources obtained by the support team can be used to replenish the resources of the attack teams.

### Apparatus Embodiment

FIG. 7 shows a schematic diagram of the configuration structure of an apparatus for processing game information according to embodiments of the disclosure. As shown in FIG. 7, the game information processing apparatus 700 includes a display module 710, a receiving module 720, and a matching module 730.

The display module 710 is configured to display on a game interface of a user a plurality of virtual characters that participate in a virtual combat and are shown entering a first phase of the virtual combat, wherein the first phase is configured to determine a target virtual character that acts with a preset identity in the virtual combat, and the plurality of virtual characters includes a first virtual character of the user;

The receiving module 720 is configured to, during the first phase, receive a first input from the first virtual character for selecting a candidate character from a candidate group, and to display the target virtual character determined based on the first input from the plurality of virtual characters for selecting candidate characters from the candidate group; wherein the candidate group comprises at least a portion of the plurality of virtual characters;

The matching module 730 is configured to display on the game interface the plurality of virtual characters entering a second phase of the virtual combat, and to match an attack route in the virtual combat for the target virtual character determined in the first phase.

In some embodiments, the game information processing apparatus 700 further includes a selection module, which is configured to: during the first phase, display on the game interface selection options corresponding to each candidate character within the candidate group; wherein the candidate group is determined based on character attributes of the plurality of virtual characters, and the candidate group comprises a portion of the plurality of virtual characters, and the selection options comprise character information and selection controls of corresponding candidate characters.

The receiving module 720 is also configured to receive the first input from the first virtual character to execute selection of a candidate character by triggering the selection control.

In some embodiments, the game information processing apparatus 700 also includes a determination module, which is configured to: during the second phase, display on the game interface candidate results of the plurality of virtual characters selecting candidate characters from the candidate group, and to determine an attack route for each target virtual character based on priorities thereof reflected by the candidate results; wherein the attack routes corresponding to different target virtual characters differ at least in a preset first route attribute.

In some embodiments, the game information processing apparatus 700 also includes a preview module, which is configured to: during the second phase, receive a second input executed by the first virtual character through triggering a first preview control to preview a first attack route matched for the second virtual character, and to display first route information of the first attack route based on the second input; wherein the first route information comprises first attack strongholds configured for the first attack route in the virtual combat; or to receive a third input executed by the first virtual character through triggering a second preview control to preview a second attack route matched for the third virtual character, and to display second route information of the second attack route based on the third input; wherein the second route information comprises second attack strongholds configured for the second attack route in the virtual combat, and at least a portion of the first attack strongholds and the second attack strongholds have different geographical locations in the virtual combat.

In some embodiments, the game information processing apparatus 700 also includes a response module, which is configured to: during the second phase, in response to an attack indication from the first virtual character to initiate an attack on the fourth virtual character, display that the first virtual character is prohibited from initiating an attack on the fourth virtual character.

In some embodiments, the game information processing apparatus 700 also includes an approval module, which is configured to: display configuration of an attack team by the first virtual character, wherein the virtual characters in the attack team attack along the attack route; in response to an application by the fifth virtual character to join the attack team, display an application approval option for the fifth virtual character; and when the first virtual character indicates agreement with the application approval option, display the fifth virtual character joining the attack team.

In some embodiments, the game information processing apparatus 700 also includes a replenishment module, which is configured to: during a third phase, display the attack team initiating an attack along the attack route; and to display the attack team receiving resource replenishments from a support team, wherein the support team includes virtual characters from the plurality of virtual characters other than those in the attack team.

### Device Embodiment

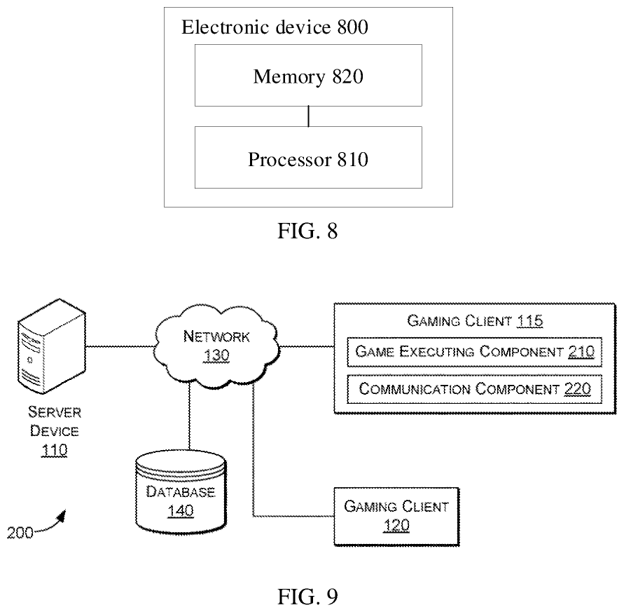

FIG. 8 shows a schematic diagram of the hardware structure of an electronic device according to some other embodiments. As shown in FIG. 8, the electronic device 800 includes a processor 810 and a memory 820. The memory 820 is configured to store a computer program, which is configured to control the processor 810 to operate, thereby controlling the electronic device 800 to perform the method for processing game information according to any embodiment of the present disclosure.

Embodiments of the disclosure also provide a computer-readable storage medium that stores a computer program, wherein the computer program, when executed by a processor, implement the method for processing game information according to any embodiment of the disclosure.

Embodiments of the disclosure also provide a computer program product that includes a computer program or instructions, wherein the computer program or instructions, when executed by a processor, implement the method for processing game information according to any embodiment of the disclosure. The computer program product is for example a game client.

Turning now to FIG. 9, a schematic depiction is provided illustrating one exemplary operating environment 200 of which an embodiment of the present disclosure can be employed. It should be understood that this and other arrangements described herein are set forth only as examples. Other arrangements and elements (e.g., machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The operating environment 200 of FIG. 9 includes a server device 110 that provides a service to one or more client devices, such as gaming clients 115,120, for instructing game play and/or settings in a virtual gaming environment over a network 130, such as the Internet. The gaming clients 115,120 may implement a computerized system for providing information processing in a game. In some embodiments, the gaming clients 115,120 may be mobile electronic devices having touchscreens thereon, such as smart phones, tablets, or laptop computers. The server device 110 and the gaming clients 115,120 may communicate in a wired or wireless manner over the network 130.

In some embodiments, the server device 110 is coupled, directly or indirectly, to a database 140 for facilitating the storage and querying of records corresponding to a plurality of game play instructions, actions, objects (e.g., virtual game pieces/characters, weapons, buildings, etc.), maps, and/or settings. The database 140 includes, among other things, a relational database or similar storage structure accessible by the server device 110. In accordance with embodiments described herein, the database 140 stores a plurality of records that each corresponds to game play instructions, actions, objects, maps, and/or settings.

The server device 110 includes a gaming server accessible by any of the gaming clients 115,120 and/or a data server for supporting an application of any of the gaming clients 115,120, over the network 130. The gaming server can support any type of application, including those that facilitate live game play. The server device 110 can further determine relationships (e.g., teams) between the gaming clients 115,120. In various embodiments, the server device 110 communicates actions commanded via one or more of the gaming clients 115,120, to another one or more of the gaming clients 115,120 for presentation thereon via user interfaces or the like, as later described herein.

Network 130 may be wired, wireless, or both. Network 130 may include multiple networks, or a network of networks, but is shown in simple form so as not to obscure aspects of the present disclosure. By way of example, network 130 can include one or more wide area networks (WANs), one or more local area networks (LANs), one or more public networks, such as the Internet, one or more private networks, and/or one or more telecommunications networks. Where network 130 includes a wireless telecommunications network, components such as a base station, a communications tower, or even access points (as well as other components) may provide wireless connectivity. Networking environments are commonplace in enterprise-wide computer networks, intranets, and the Internet. Accordingly, network 130 is not described in significant detail.

In accordance with embodiments of the present disclosure, the server device 110 or the gaming clients 115, 120 can each be a computing device that is capable of accessing the Internet, such as the World Wide Web, and/or a telecommunications network. Either one of the server device 110 or the gaming clients 115, 120 might take on a variety of forms, such as a personal computer (PC), a laptop computer, a mobile phone, a tablet computer, a wearable computer, a personal digital assistant (PDA), an MP3 player, a global positioning system (GPS) device, a video player, a handheld communications device, a smartphone, a smart watch, a workstation, any combination of these delineated devices, or any other suitable device.

It should be understood that any number of the aforementioned devices may be employed in operating environment 200 within the scope of the present disclosure. Each may comprise a single device or multiple devices cooperating in a distributed environment. Additionally, other components not shown may also be included within the distributed environment. It should further be understood that operating environment 200 shown in FIG. 9 is an example of one suitable computing system architecture. Each of the servers, gaming clients, networks, and databases shown in FIG. 9 may be implemented via a computing device, such as computing device 600. The components may communicate with each other via network 130.

FIG. 9 also depicts operational modules of an exemplary one of the gaming clients, specifically gaming client 115, in accordance with some embodiments of the present disclosure. It is noted that the depicted implementation is merely exemplary, and not intended to be limiting in any way, as each component can be arranged in various configurations, spread across a number of computing devices, combined with other components or one another, arranged to communicate over a network, or any combination of the foregoing including others not mentioned. For example, each of the operational modules may comprise a combination of hardware components and/or computer instructions stored on computer-readable media or a memory and executable on a processor thereof.

As depicted in FIG. 9, the operational modules of the gaming client 115 may comprise a game executing component 210 and a communication component 220. The game executing component 210 can be configured for executing a battle game as described above. The communication component 220 can be configured for network communications between the gaming client 115, the gaming client 120, and/or the server device 110 via network 130.

The various embodiments described in this specification are presented in a progressive manner. For the parts that are identical or similar among different embodiments, reference can be made to each other; each embodiment focuses on aspects that differ from other embodiments. In particular, for apparatus and device embodiments, as they are basically similar to method embodiments, they are described more simply, and relevant details can be referred to in the description of the method embodiments.

The specific embodiments described above pertain to this specification. Other embodiments fall within the scope of the appended claims. In some cases, the actions or steps recited in the claims can be performed in an order different from that of the embodiments and still achieve desired results. Additionally, processes depicted in the accompanying drawings do not necessarily require the particular order shown or sequential order to achieve desired results. In certain embodiments, multitasking and parallel processing may also be feasible or advantageous.

The embodiments of this specification can be a device, method, and/or computer program product. The computer program product can include a computer-readable storage medium having computer-readable program instructions thereon for causing a processor to implement various aspects of the embodiments described herein.

A computer-readable storage medium can be any tangible device capable of storing and maintaining instructions used by an instruction execution device. Such media can be, but is not limited to, electronic storage devices, magnetic storage devices, optical storage devices, electromagnetic storage devices, semiconductor storage devices, or any suitable combination thereof. More specific examples (a non-exhaustive list) of the computer-readable storage medium include: portable computer disks, hard drives, random access memory (RAM), read-only memory (ROM), erasable programmable read-only memory (EPROM or flash memory), static random-access memory (SRAM), portable compact disc read-only memory (CD-ROM), digital versatile discs (DVDs), memory sticks, floppy disks, mechanically encoded devices such as punch cards or raised structures in a groove having instructions recorded thereon, and any suitable combination of the foregoing. Herein, the computer-readable storage medium is not interpreted as transitory signals per se, such as radio waves or other freely propagating electromagnetic waves, electromagnetic waves propagating through waveguides or other transmission media (e.g., light pulses through fiber-optic cables), or electrical signals transmitted via wires.

The computer-readable program instructions described herein can be downloaded to respective computing/processing devices from a computer-readable storage medium, or can be downloaded over a network, such as the Internet, local area network (LAN), wide area network (WAN), and/or wireless network, to an external computer or external storage device. Networks may include copper transmission cables, optical transmission fibers, wireless transmission, routers, firewalls, switches, gateway computers, and/or edge servers. Each computing/processing device's network adapter card or network interface receives computer-readable program instructions from the network and forwards the computer-readable program instructions for storage in a computer-readable storage medium within the respective computing/processing device.

Computer program instructions executed to perform operations of the embodiments described herein can be assembly instructions, instruction set architecture (ISA) instructions, machine instructions, machine-dependent instructions, microcode, firmware instructions, state-setting data, or source code or object code written in any combination of one or more programming languages, including an object-oriented programming language such as Smalltalk, C++ or the like, and conventional procedural programming languages, such as the “C” programming language or similar programming languages. The computer-readable program instructions can execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a LAN or WAN, or the connection may be made to an external computer (for example, through the Internet using an Internet Service Provider). In some embodiments, electronic circuits, such as programmable logic circuits, field-programmable gate arrays (FPGA), or programmable logic arrays (PLA), can be customized by utilizing the state information of the computer-readable program instructions to perform various aspects of the embodiments described herein.

Various aspects of the embodiments of this specification have been described with reference to flowcharts and/or block diagrams according to the methods, apparatuses (devices), and computer program products. It should be understood that each block of the flowchart and/or block diagram, as well as combinations of blocks in the flowchart and/or block diagram, can be implemented by computer-readable program instructions.

These computer-readable program instructions can be provided to a processor of a general-purpose computer, special-purpose computer, or other programmable data processing apparatus to produce a machine, such that these instructions, when executed via the processor of the computer or other programmable data processing apparatus, create means for implementing the functions/actions specified in one or more blocks of the flowchart and/or block diagram. The computer-readable program instructions can also be stored in a computer-readable storage medium that can direct a computer, programmable data processing apparatus, and/or other devices to function in a particular manner, thus creating an article of manufacture including instructions which implement the function/action specified in one or more blocks of the flowchart and/or block diagram.

The computer-readable program instructions can also be loaded onto a computer, other programmable data processing apparatus, or other device to cause a series of operational steps to be performed on the computer, other programmable apparatus, or other device to produce a computer-implemented process, so that the instructions which execute on the computer, other programmable apparatus, or other device implement the functions/actions specified in one or more blocks of the flowchart and/or block diagram.

Flowcharts and block diagrams in the Figures illustrate the architecture, functionality, and operation of possible implementations of systems, methods, and computer program products according to various embodiments of the present specification. In this regard, each block in the flowchart or block diagram can represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagram and/or flowchart illustration, and combinations of blocks in the block diagram and/or flowchart illustration, can be implemented by special purpose hardware-based systems that perform the specified functions or acts or carry out combinations of special purpose hardware and computer instructions. It is well known to those skilled in the art that implementation by hardware only, by software only, and by a combination of hardware and software are equivalent.

The above description has been provided for the embodiments of the present specification. The description is illustrative and not exhaustive, and does not limit the disclosed embodiments. Many modifications and changes will be apparent to those of ordinary skill in the art without departing from the scope of the appended claims. Terms chosen herein are intended to best explain the principles of the embodiments, practical applications, or improvements to technologies in the market, or to enable others of ordinary skill in the art to understand the disclosed embodiments.

1. An information processing method for implementation by a device that executes a game, comprising:
displaying, by a processor, on a game interface of a user a plurality of virtual characters that participate in a virtual combat and enter a first phase of the virtual combat, wherein the first phase is configured to determine a target virtual character with a preset identity in the virtual combat, and the plurality of virtual characters comprises a first virtual character of the user;
receiving, by the processor during the first phase, a first input from the first virtual character for selecting a first candidate character from a candidate group,
displaying, on the interface by the processor, the target virtual character determined based on the first input from the plurality of virtual characters for selecting second candidate characters from the candidate group; wherein the candidate group comprises at least a portion of the plurality of virtual characters, and
displaying, on the game interface by the processor, the plurality of virtual characters entering a second phase of the virtual combat, and matching, by the processor, an attack route in the virtual combat for the target virtual character determined during the first phase.

2. The method of claim 1, further comprising:
displaying, on the game interface by the processor during the first phase, selection options corresponding to each candidate character in the candidate group; wherein the candidate group is determined based on character attributes of the plurality of virtual characters, and the candidate group comprises a portion of the plurality of virtual characters, and the selection options comprise character information and selection controls corresponding to candidate characters;
the receiving a first input from the first virtual character for selecting a first candidate character from a candidate group, comprises:
receiving, by the processor, the first input from the first virtual character to execute a selection of a first candidate character by triggering a selection control.

3. The method of claim 1, wherein there are provided at least two of the target virtual characters; the method further comprising:
displaying, on the game interface by the processor during the second phase, candidate results of the plurality of virtual characters selecting candidate characters from the candidate group, and
determining, by the processor, an attack route for each target virtual character based on priorities thereof reflected by the candidate results;
wherein the attack routes corresponding to different target virtual characters differ at least in a preset first route attribute.

4. The method of claim 3, wherein at least two of the target virtual characters comprise a second virtual character and a third virtual character, the method further comprising:
receiving, by the processor during the second phase, a second input executed by the first virtual character through triggering a first preview control to preview a first attack route matched for the second virtual character, and displaying, on the game interface by the processor, first route information of the first attack route based on the second input; wherein the first route information comprises first attack strongholds configured for the first attack route in the virtual combat; or
receiving, by the processor, a third input executed by the first virtual character through triggering a second preview control to preview a second attack route matched for the third virtual character, and displaying, on the game interface by the processor, second route information of the second attack route based on the third input; wherein the second route information comprises second attack strongholds configured for the second attack route in the virtual combat, and at least a portion of the first attack strongholds and the second attack strongholds have different geographical locations in the virtual combat.

5. The method of claim 4, wherein the preset first route attribute comprises:
a quantity of attack strongholds indicated for attacks along the attack route;
a quantity of resources obtained after occupying the attack strongholds indicated for attacks along the attack route; and
an attribute strength preset for the attack strongholds indicated for attacks along the attack route.

6. The method of claim 1, wherein the plurality of virtual characters comprise a fourth virtual character, the fourth virtual character being in the same camp as the first virtual character in the virtual combat; the method further comprising:
displaying, on the game interface by the processor during the second phase, that the first virtual character is prohibited from initiating an attack on the fourth virtual character, in response to an attack indication from the first virtual character to initiate an attack on the fourth virtual character,

7. The method of claim 1, wherein the plurality of virtual characters comprise a fifth virtual character, the fifth virtual character being in the same camp as the first virtual character in the virtual combat; when the first virtual character has the preset identity, the method further comprising:
displaying, on the game interface by the processor, a configuration of an attack team by the first virtual character, wherein the virtual characters in the attack team attack along the attack route;
displaying, on the game interface by the processor, an approval option of an application for the fifth virtual character, in response to the application by the fifth virtual character to join the attack team; and
displaying, on the game interface by the processor, the fifth virtual character joining the attack team, when the first virtual character indicates an agreement with the approval option of the application.

8. The method of claim 7, further comprising:
displaying, on the game interface by the processor during a third phase, the attack team initiating an attack along the attack route; and
displaying, on the game interface by the processor, the attack team receiving resource replenishments from a support team, wherein the support team includes virtual characters from the plurality of virtual characters other than those in the attack team.

9. A computerized system for providing information processing in a game, comprising:
an interface display;
a memory, configured for storing a computer program; and
a processor, configured for executing an information processing method according to claim 1, under control of the computer program.

10. The system of claim 9, comprising:
displaying, on the game interface by the processor during the first phase, selection options corresponding to each candidate character in the candidate group; wherein the candidate group is determined based on character attributes of the plurality of virtual characters, and the candidate group comprises a portion of the plurality of virtual characters, and the selection options comprise character information and selection controls corresponding to candidate characters;
the receiving a first input from the first virtual character for selecting a candidate character from a candidate group, comprises:
receiving, by the processor, the first input from the first virtual character to execute selection of a candidate character by triggering a selection control.

11. The system of claim 9, wherein there are provided at least two of the target virtual characters, comprising:
displaying, on the game interface by the processor during the second phase, on the game interface candidate results of the plurality of virtual characters selecting candidate characters from the candidate group, and determining, by the processor, an attack route for each target virtual character based on priorities thereof reflected by the candidate results; wherein the attack routes corresponding to different target virtual characters differ at least in a preset first route attribute.

12. The system of claim 11, wherein at least two of the target virtual characters comprise a second virtual character and a third virtual character, comprising:
receiving, by the processor during the second phase, a second input executed by the first virtual character through triggering a first preview control to preview a first attack route matched for the second virtual character, and displaying, on the game interface by the processor, first route information of the first attack route based on the second input; wherein the first route information comprises first attack strongholds configured for the first attack route in the virtual combat; or
receiving, by the processor, a third input executed by the first virtual character through triggering a second preview control to preview a second attack route matched for the third virtual character, and displaying, by the processor, second route information of the second attack route based on the third input; wherein the second route information comprises second attack strongholds configured for the second attack route in the virtual combat, and at least a portion of the first attack strongholds and the second attack strongholds have different geographical locations in the virtual combat.

13. The system of claim 12, wherein the preset first route
a quantity of attack strongholds indicated for attack along the attack route;
quantity of resources obtained after occupying the attack strongholds indicated for attack along the attack route; and
attribute strength preset for the attack strongholds indicated for attack along the attack route.

14. The system of claim 9, wherein the plurality of virtual characters comprises a fourth virtual character, and the fourth virtual character being in the same camp as the first virtual character in the virtual combat, comprising:
displaying, on the game interface by the processor during the second phase, that the first virtual character is prohibited from initiating an attack on the fourth virtual character, in response to an attack indication from the first virtual character to initiate an attack on the fourth virtual character.

15. The system of claim 9, wherein the plurality of virtual characters comprises a fifth virtual character, the fifth virtual character being in the same camp as the first virtual character in the virtual combat, when the first virtual character has the preset identity, comprising:
displaying, on the game interface by the processor, configuration of an attack team by the first virtual character, wherein the virtual characters in the attack team attack along the attack route;
displaying, on the game interface by the processor, an approval option of an application for the fifth virtual character, in response to the application by the fifth virtual character to join the attack team; and
displaying, on the game interface by the processor, the fifth virtual character joining the attack team, when the first virtual character indicates agreement with the application approval option.

16. The system of claim 15, comprising:
during a third phase, displaying, by the processor, the attack team initiating an attack along the attack route; and
displaying, by the processor, the attack team receiving resource replenishments from a support team, wherein the support team includes virtual characters from the plurality of virtual characters other than those in the attack team.

17. A non-transitory computer-readable storage medium for storing instructions, wherein when executed by a processor, the instructions instruct the processor to perform a method for information processing in a game according to claim 1.

18. The non-transitory computer-readable storage medium of claim 17, comprising:
displaying, on the game interface by the processor during the first phase, selection options corresponding to each candidate character in the candidate group; wherein the candidate group is determined based on character attributes of the plurality of virtual characters, and the candidate group comprises a portion of the plurality of virtual characters, and the selection options comprise character information and selection controls corresponding to candidate characters;
the receiving a first input from the first virtual character for selecting a candidate character from a candidate group, comprises:
receiving, by the processor, the first input from the first virtual character to execute selection of a candidate character by triggering a selection control.

19. The non-transitory computer-readable storage medium of claim 17, wherein there are provided at least two of the target virtual characters, comprising:
displaying, on the game interface by the processor during the second phase, on the game interface candidate results of the plurality of virtual characters selecting candidate characters from the candidate group, and determining, by the processor, an attack route for each target virtual character based on priorities thereof reflected by the candidate results;
wherein the attack routes corresponding to different target virtual characters differ at least in a preset first route attribute.

20. The non-transitory computer-readable storage medium of claim 19, wherein at least two of the target virtual characters comprise a second virtual character and a third virtual character, comprising:
receiving, by the processor during the second phase, a second input executed by the first virtual character through triggering a first preview control to preview a first attack route matched for the second virtual character, and displaying, on the game interface by the processor, first route information of the first attack route based on the second input;
wherein the first route information comprises first attack strongholds configured for the first attack route in the virtual combat; or
receiving, by the processor, a third input executed by the first virtual character through triggering a second preview control to preview a second attack route matched for the third virtual character, and displaying, by the processor, second route information of the second attack route based on the third input; wherein the second route information comprises second attack strongholds configured for the second attack route in the virtual combat, and at least a portion of the first attack strongholds and the second attack strongholds have different geographical locations in the virtual combat.
